(19) United States
(12) Patent Application Publication
(10) Pub. No.: US 2010/0133074 A1
(43) Pub. Date: Jun. 3, 2010

(54) LOCKING DEVICE FOR AN INSTALLATION SWITCH DEVICE

(75) Inventors: Klaus-Peter Eppe, Waldbrunn (DE); Erwin Muders, Heidelberg (DE); Hermann Schmitt, Edingen-Neckarhausen (DE)

Correspondence Address: Darby & Darby, P.O. Box 770, Church Street Station, New York, NY, 10008-0770, US

(73) Assignee: ABB AG, Mannheim (DE)

(21) Appl. No.: 12/595,923

(22) PCT Filed: Apr. 14, 2008
(86) PCT No.: PCT/EP08/02958

§ 371 Date: Oct. 14, 2009

(30) Foreign Application Priority Data
Apr. 19, 2007 (DE) 10 2007 018 522.9
Apr. 14, 2008 (DE) 10 2008 018 892.1

(51) Int. Cl. H01H 9/20

(52) U.S. Cl. 200/43.16

(57) ABSTRACT

A locking apparatus for prevention of unauthorized switching-on of a service switching device includes a release lever disposed within a device housing, a switching mechanism movable from a latched state to an unlatched state by the release lever, and a release lever actuating part disposed in an area of the device housing in which the release lever is disposed. The release lever actuating part is movable from outside the switching device between a switched-on position and a switched-off position. The release lever actuating part is coupled to the release lever so as to hold the release lever in the unlatched state when the release lever actuating party is in the switched-off position.

The invention relates to a locking apparatus for prevention of unauthorized switching-on of a service switching device, having a switching mechanism which can be moved from a latching state to an unlatching state by a release lever, as claimed in the preamble of claim 1, and to a service switching device having a locking apparatus such as this as claimed in claim 8.

Service switching devices, such as a selective main line circuit breaker or a non-selective line circuit breaker, normally comprise at least one contact point which is formed from a fixed contact piece and a moving contact piece which is located on a contact lever, feed and outgoer terminals, a control lever for control from the outside as well as a switching mechanism which can be operated by the control lever and interacts with the contact lever such that the contact point is closed when the switching mechanism is in a latching state and the contact point is permanently open when the switching mechanism is in an unlatching state. When the switching mechanism is latched, current can therefore flow from the input terminal to the output terminal via the contact point, while this current path is interrupted when the switching mechanism is unlatched.

The control lever can be used to move the switching mechanism to the latched state, that is to say switched on, or to the unlatched state, that is to say switched off In addition, release devices are also provided in the interior of the service switching device which, when specific faulty operating states occur in the circuit being monitored by the service switching device, such as a short circuit or overcurrent, act on the switching mechanism such that it is moved to the unlatched state when it was in the latched state before release. For this purpose, the switching mechanism has a release lever which may be either in a latching position or in an unlatching position. When the release lever is in the latching position, then the switching mechanism can be latched by the control lever. When the release lever is in the unlatching position, then the switching mechanism is unlatched if it was previously latched. When the switching mechanism is unlatched and the release lever is held firmly in the unlatching position, the switching mechanism cannot be latched again.

The release lever is normally held in the latching position by a restraint spring. When a short-circuit current or overcurrent occurs, the corresponding release device acts on the release lever such that it is moved briefly from the latching position to the unlatching position, as a result of which the switching mechanism is unlatched, and is then moved immediately back again to the latching position by the restraint spring.

It is often necessary to ensure that a service switching device can be switched on again from the switched-off state only by personnel who are authorized to do so. For example, if the main line circuit breaker is switched off because maintenance work is being carried out on the electrical installation in a building, it should be possible, in order to allow the work to be carried out safely, to prevent someone who is unauthorized from switching the switch on again, because this should be done only by a person authorized to do so, after the maintenance work has been completed correctly.

In the case of devices according to the prior art that are currently available, this problem is generally solved by fitting an additional cover cap or some other mechanical blocking apparatus externally to the control lever, which prevents operation of the control lever, and can be removed again only by the person authorized to do so. Since authorized personnel are often employees of the utility company, a blocking apparatus such as this is also referred to as a “utility company lock”.

However, this requires a part which is additionally fitted externally to the service switching device, resulting in considerable additional complexity in manufacture and the supply of spare parts. In addition, there are safety gaps, since the externally fitted blocking apparatus can also incorrectly be fitted in the switched-on state.

DE 10 2004 019 174 A1 discloses a locking apparatus of this generic type wherein, in this case, a release lever actuating apparatus is arranged in the interior of the switching device and can be moved from outside the service switching device between a switched-on position and a switched-off position, such that, in the switched-off position, the release lever is held in the unlatching position. The release actuating apparatus is in this case a slide which can be moved by an actuating part, which is mounted such that it can rotate and can be operated from the outside only by means of a special tool. An apparatus such as this still always requires an additional part in the interior of the service switching device, specifically the additional slide, and is therefore complex.

The object of the present invention is therefore to simplify even further a locking apparatus of this generic type.

The object is achieved by a locking apparatus of this generic type having the characterizing features of claim 1, and by a service switching device having a locking apparatus such as this as claimed in claim 8.

Thus, according to the invention, the release lever actuating part is fitted in that area of the housing in which the release lever of the switching mechanism is also located, and in its switched-off position, the release lever actuating part is coupled to the release lever such that, in the switched-off position, it holds the release lever in its unlatching position.

According to one particularly advantageous embodiment of the invention, a pin is fitted to the release lever actuating part, points into the interior of the switching device toward the release lever, and is coupled to the release lever, when the release lever actuating part is in the switched-off position.

In one advantageous development of the invention, the release lever actuating part is mounted such that it can rotate about a rotation shaft which points toward the release lever, and the pin is fitted to the release lever actuating part, eccentrically with respect to the rotation shaft.

The release lever actuating part is fitted to and corresponds to the release lever such that, when the actuating part is in the locking position, the pin acts directly on a projection on the release lever, and therefore holds this firmly in the unlatching position.

The release lever can therefore not lock the latching point with the catch lever, and the switching handle is disengaged.

According to one particularly advantageous embodiment, the pin has an incline which, when the actuating part is turned in toward the projection on the release lever, interacts with a flank of the projection and thus constantly pivots the release lever toward the unlatched position.

According to a further advantageous embodiment, the release lever is a double-armed lever. It has a first arm, the so-called latching arm, which is fitted at its free end with a tab which, in the latched state, interacts with the latching surface on the catch lever. It has a second arm, the release arm, on which the projection protrudes in the vicinity of the rotation shaft and approximately at right angles from the second arm in the direction of the front front face, and to which the pin of the release lever actuating part is coupled in the switched-off position.

According to a further advantageous embodiment, the control face of the release lever actuating part is fitted to the front device front face, and the switching mechanism, together with the release lever, is fitted close to the front device front face.

In one particularly advantageous refinement of the invention, the release lever actuating part can be operated only by means of a special tool. Special tools such as these can be made available exclusively to personnel authorized for this purpose, for example to the utility company maintenance and repair personnel, by organizational measures.

The advantage of a locking apparatus according to the invention is the direct action of the release lever actuating part on the release lever. This saves the slide, thus allowing the service switching device to be designed to be simple and less susceptible to faults.

Further advantageous refinements and improvements of the invention, as well as further advantages, can be found in the dependent claims.

The invention as well as further advantageous refinements and improvements of the invention will be explained and described in more detail with reference to the drawings, which illustrate one exemplary embodiment of the invention, and in which:

FIG. 1 shows one embodiment of a locking apparatus according to the invention, in which the release lever actuating part is in the switched-on position;

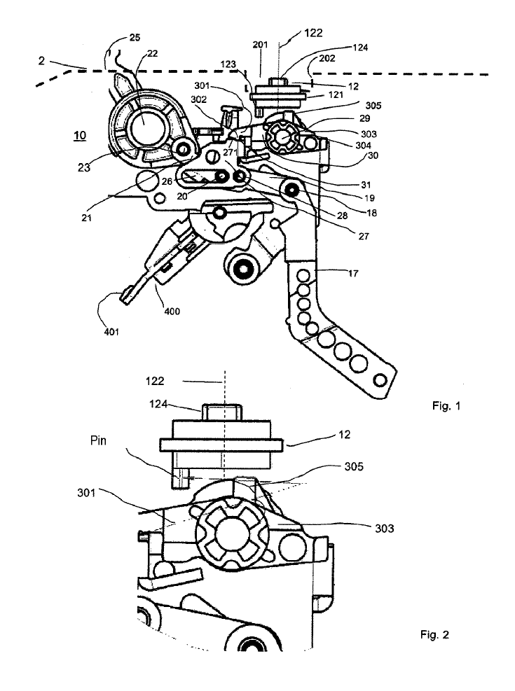

FIG. 2 shows a detail view from FIG. 1,

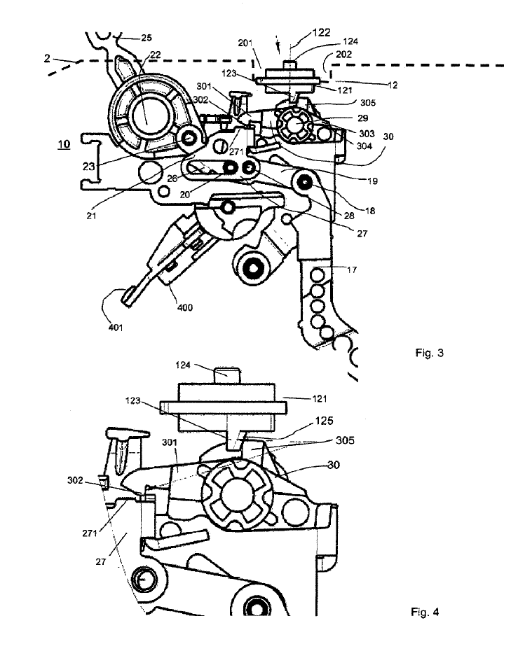

FIG. 3 shows the embodiment of a locking apparatus according to the invention as in FIG. 1, with the release lever actuating part in the switched-off position, and

FIG. 4 shows a detailed view of FIG. 3.

FIG. 1 will be considered first of all. FIG. 1 shows a locking apparatus according to the invention, comprising a switching mechanism 10 and a release lever actuating part 12. The switching mechanism 10 and the locking apparatus 12 are installed in a service switching device, for example a main line circuit breaker. The main line circuit breaker itself is only indicated here by the device front face 2 of the housing, indicated by dashed lines. In general, a main line circuit breaker is known in principle as such. The switching mechanism of a main line circuit breaker according to the invention is fitted underneath the housing wall 2 in that area in which a release lever actuating part 12 is provided which can be pivoted on a plane parallel to the housing wall 2. A pin 123 is fitted, in this case integrally formed, on the release lever actuating part 12, and extends toward the switching mechanism 10. When the release lever actuating part 12 is being pivoted on the plane parallel to the housing wall 2, the release lever 30 of the switching mechanism 10 can be held in its unlatching position by the pin 123. In the example shown here, the housing wall 2 is the front front face of a dielectric housing of the service switching device.

The core of the switching mechanism 10 is a latching point 31, formed by the interaction of a tab 302 on the latching arm 301 of a release lever 30 with the latching surface of a catch lever 27.

A control lever 17 is connected via a rotating pin 18 to a first intermediate lever 19. This is connected in an articulated manner by a hinge pin 20 to a second intermediate lever 21, which is articulated on a hinge shaft 23 on a switching toggle 24 with a switching handle 25. The switching toggle 24 is mounted on a fixed-position shaft 22.

The hinge pin 20 is guided such that it can move in an elongated hole 26 in the catch lever 27. The catch lever 27 is mounted in a fixed position such that it can rotate about a rotation shaft 28. The catch lever 27 together with a release lever 30, which is mounted such that it can rotate about a shaft 29 that is mounted in a fixed position, forms a latching point 31.

The release lever 30 is in the form of a double-armed lever whose first arm 301, inclined toward the latching point, and also referred to as the latching arm, is fitted with a tab 302 which, together with a tab 271 on the catch lever 27, forms the latching point 31. The second arm 303, which points away from the latching point 31, of the release lever 30, also referred to as the release arm, is fitted with a tab 304. The thermal release or releases of the switch act on this tab 304 for example via a slide, which is not illustrated here. The influence of the thermal release pivots the release lever 30 in the clockwise direction during the release process, such that the tab 302 releases the tab 271, thus unlatching the latching point 31.

The switching mechanism is used either to permanently open or close a disconnection contact point, which comprises a moving contact piece 401 mounted on a contact mount arm 400 and a fixed contact piece which is not illustrated, by manual operation by means of a switching handle, or to open the closed disconnection contact point in response to the influence of a release member, and to hold it permanently open. The influence of the release member is created via the release lever 30, to be precise such that, when the release member is activated, the release lever 30 is rotated such that the tab 302 on its latching arm 301 is released from the latching surface 271 of the catch lever 27, and thus unlatches the latching point 31.

The illustrated switching mechanism could, for example be part of the switching mechanism of a selective main line circuit breaker. The release member may then be a thermal release or a magnetic quick-action release, both of which act in a suitable manner via a release slide, which is not illustrated, on the release arm 303 of the release lever 30. The switching mechanism 10 is connected via the control lever 17, as shown in FIG. 1, to a further contact lever, which is part of a main contact point in the main line circuit breaker, not illustrated here. When the switching handle 25 is used to switch on manually, both the disconnection contact point and the main contact point are closed, and both are open when switched off manually.

The switching handle 25 can be used for switching on manually only when the latching point 31 is latched. If the latching point 31 is held in its unlatched position, then the switching handle 25 runs free, and the disconnection contact point as well as the main contact point remain open.

The release lever 30 is fitted with a projection 305 which projects from the release lever, approximately at right angles to its longitudinal extend direction, in the direction of the device front face 2, and is fitted approximately in the vicinity of the rotation shaft 201 of the release lever.

The release lever actuating part 12 comprises an approximately base body 121, which is mounted in a recess in the housing wall such that it can rotate about a fixed-position rotation shaft 122, which is oriented approximately at right angles to the longitudinal extend direction of the release lever 30, and is thus mounted n a plane parallel to the housing wall, such that it can pivot about the shaft 122. A pin 123 is fitted eccentrically to the base body 121. When the release lever actuating part 12 is in the switched-on position as shown in FIGS. 1 and 2, this pin 123 is at a distance from the release lever projection 305, which distance is sufficiently great that the release lever 30 can pivot about its shaft 29 without any impediment.

The imaginary extension of the shaft 123 of the release lever of the actuating part 12 intersects the release lever 30 close to its shaft 29. The physical proximity that this results in between the release lever actuating point 12 and the release lever projection 305 is important in order to allow the release lever actuating part 12 to hold the release lever 30 fixedly in the release position without any further intermediate part.

FIGS. 3 and 4 will now be considered. In the switched-off position shown in FIGS. 3 and 4, the release lever actuating part 12 has been rotated through 90°. The pin 123 on the release lever actuating part 12 now rests on the release lever projection 305 and holds this pivoted in the clockwise direction such that the tab 302 on the latching arm 301 is lifted off the latching surface of the catch lever. In this position, the latching point 31 is therefore unlatched, and it is impossible to switch the service switching device on manually.

On its side facing the device front face 2, the release lever actuating part 12 has an operating part 124 which allows engagement with a special tool. The operating part 124 is designed such that the release lever actuating part 12 can be rotated only by means of this special tool. Once it has been moved to the switched-off position, the service switching device can therefore be rotated back to the switched-on position again only by the person who is authorized to do so and has the special tool in order to indicate his authorization.

By way of example, the operating part 124 is a pin with a specially shaped circumferential contour, for example a hexagon with dimensions which do not match any of the conventional and standardized screwdriver cross sections.

An outer pin which is mounted such that it can rotate and forms the operating part 124 projects at the center of a recess 201, which is in the form of a blind hole, with this recess 201 being located at that point on the device front face 2 at which the operating part 124 can be seen. In addition to the circumferential contour of the pin, the distance between the pin and the side walls 202 of the recess 201 is also of such size that only the special tool that has already been mentioned can be inserted in order to rotate the operating part 124.

The pin 123 of the release lever actuating part 12 has an incline 25. This ensures that, when the release lever actuating part 12 is rotated to the switched-off position, the external circumferential contour of the pin 123 on the release lever actuating part interacts in a sliding form with the release lever projection 305, thus preventing a tilting or jamming

### LIST OF REFERENCE SYMBOLS

2 Switching device front face
10 Switching mechanism
12 Release lever actuating part
17 Control lever
18 Rotating pin
19 First intermediate lever
20 Hinge pin
21 Second intermediate lever
22 Fixed-position shaft
23 Hinge shaft
24 Switching toggle
25 Switching handle
26 Elongated hole in the catch lever
27 Catch lever
28 Rotation shaft of the catch lever
29 Shaft of the release lever
30 Release lever
31 Latching point
121 Cylindrical base body
122 Fixed-position rotation shaft
123 Pin of the release lever actuating part
124 Operating part
125 Incline
201 Recess
202 Side wall of the recess
271 Tab on the catch lever, latching surface
301 Latching arm
302 Tab on the release lever
303 Release arm
304 Tab
305 Release lever projection
400 Contact mount arm
401 Moving contact piece

1-15. (canceled)

16. A locking apparatus for prevention of unauthorized switching-on of a service switching device comprising:
a release lever disposed within a device housing;
a switching mechanism movable from a latched state to an unlatched state by the release lever; and
a release lever actuating part disposed in an area of the device housing in which the release lever is disposed, wherein the release lever actuating part is movable from outside the switching device between a switched-on position and a switched-off position, and wherein the release lever actuating part is coupled to the release lever so as to hold the release lever in the unlatched state when the release lever actuating party is in the switched-off position.

17. The locking apparatus as recited in claim 16, further comprising a pin fitted into the release lever actuating part and pointing into an interior of the switching device toward the release lever, wherein the pin is coupled to the release lever when the release lever actuating part is in the switched-off position.

18. The locking apparatus as recited in claim 17, wherein the release lever actuating part is disposed so as to be rotatable about a rotation shaft pointing towards the release lever, and wherein the pin is fitted to the release lever actuating part eccentrically with respect to the rotation shaft.

19. The locking apparatus as recited in claim 18, wherein the pin acts directly on a projection of the release lever so as to hold the release lever in the unlatched state when the release lever actuating part is in the switched-off position.

20. The locking apparatus as recited in claim 19, wherein the pin has an incline, the incline interacting with a flank of the projection so as to pivot the release lever toward the unlatched state when the actuating part is turned in toward the projection.

21. The locking apparatus as recited in claim 16, wherein the release lever actuating part is operable from a control face outside of the device housing using a special tool.

22. The locking apparatus as recited in claim 21, wherein the release lever actuating part includes an operating part on the control face, the operating part corresponding to the special tool.

23. A service switching device comprising:
a release lever;
a device housing having a device housing wall;
a switching mechanism disposed in the device housing and movable from a latched state to an unlatched state by the release lever, wherein the switching mechanism is disposed underneath the device housing wall in an area in which a release lever actuating part, pivotable on a plane parallel to the device housing wall, is disposed; and
a pin fitted to the release lever actuating part and extending towards the release lever so as to hold the release lever in the unlatched state when the release lever actuating part pivots.

24. The service switching device as recited in claim 23, wherein the release lever is a double-armed lever including:
a latching arm disposed at a free end of the double-armed lever with a tab configured to interact with a latching surface of a catch lever; and
a release arm having a release lever projection in an area of the rotation shaft and at a right angle from the release arm in a direction of the device housing wall, wherein the pin can be coupled with the release lever projection in a switched-off position so as to hold the release lever in the unlatched state.

25. The service switching device as recited in claim 24, wherein a control face of the release lever actuating part is fitted to a switching device front face.

26. The service switching device as recited in claim 24, wherein the switching mechanism with the release lever is fitted near a switching device front face.

27. The service switching device as recited in claim 24, wherein the release lever actuating part includes an operating part disposed on a face of the release lever actuating part so as to allow engagement with a special tool.

28. The service switching device as recited in claim 27, wherein the operating part is configured so as to allow only the special tool to operate the release lever actuating part.

29. The service switching device as recited in claim 28, wherein the operating part includes a pin having a specially shaped circumferential contour matched to the special tool.

30. The service switching device as recited in claim 29, wherein a recess in a form of a blind hole is disposed at a point on the switching device front face where the operating part is visible, and wherein the operating part is disposed in an interior of the recess.
